(19) United States
(12) Patent Application Publication
(10) Pub. No.: US 2011/0142462 A1
(43) Pub. Date: Jun. 16, 2011

(54) IMAGE FORMING APPARATUS AND IMAGE FORMING METHOD

(75) Inventor: Setsuo Takada, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/967,296

(22) Filed: Dec. 14, 2010

Related U.S. Application Data
(60) Provisional application No. 61/287,006, filed on Dec. 16, 2009.

(51) Int. Cl. G03G 15/00; G03G 15/20

(52) U.S. Cl. 399/45; 399/69

(57) ABSTRACT

According to one embodiment, an image forming apparatus includes a characteristic acquiring unit configured to acquire a characteristic of the medium, a fixing device including a heating member configured to heat the front surface of the medium and a pressing member configured to heat a rear surface of the medium, and a control unit configured to turn off, when the thickness or the basis weight of the medium is determined to be equal to or smaller than a predetermined value based on an acquired characteristic of the medium, heating power for the pressing member at start of a fixing operation by the fixing device and control the temperature of the pressing member during the fixing operation to the temperature between a second threshold temperature which is temperature lower than a temperature during standby of the fixing operation, and a first threshold temperature lower than the second threshold temperature.

### CROSS-REFERENCE TO RELATED APPLICATION

This application is based upon and claims the benefit of U.S. Provisional Application No. 61/287,006, filed on Dec. 16, 2009; the entire contents of which are incorporated herein by reference.

### FIELD

Embodiments described herein relate generally to an image forming apparatus and an image forming method.

### BACKGROUND

An image forming apparatus of a quadruple tandem type in the past operates according to a procedure explained below. The image forming apparatus forms toner images respectively on the surfaces of photoconductive members for Y, M, C, and BK and transfers the toner images on the photoconductive members onto an intermediate transfer member. The intermediate transfer member transfers the toner images onto a medium. The medium having the toner images transferred thereon passes through a fixing device. The fixing device heats both the surfaces of the medium while pressing the same to fix the toner images on the medium. The medium passed through the fixing medium is discharged to a paper discharge tray.

When the medium comes into contact with the fixing device, the medium deprives the fixing device of heat. Therefore, temperature control is performed to keep the temperature of the fixing device at predetermined temperature. The temperature control is continuously carried out during a printing operation. Therefore, during the printing operation, electric power used for a heating source for the fixing device is continuously consumed.

### DESCRIPTION OF THE DRAWINGS

FIG. 1 is an exemplary overall diagram of an image forming apparatus according to an embodiment;

FIG. 2 is an exemplary overall diagram of a fixing device according to an embodiment;

FIG. 3 is an exemplary diagram for explaining a region formed by a heating member and a pressing member of the fixing device according to an embodiment;

FIG. 4 is an exemplary time chart for explaining a temperature control state of the fixing device in the case in which a power value is regulated with respect to plain paper 1 according to an embodiment;

FIG. 5 is an exemplary time chart for explaining a temperature control state of the fixing device in the case in which a power value is regulated with respect to plain paper 2 according to an embodiment;

FIG. 6 is an exemplary diagram for explaining a temperature control operation of the fixing device according to an embodiment;

FIG. 7 is an exemplary flowchart for explaining a temperature control procedure of the fixing device according to an embodiment; and

FIG. 8 is an exemplary time chart for explaining a temperature control state of the fixing device in the case in which temperature control is applied to the plain paper according to an embodiment.

### DETAILED DESCRIPTION

In general, according to one embodiment, an image forming apparatus includes: an image forming unit configured to form a toner image on a front surface of a medium; a characteristic acquiring unit configured to acquire a characteristic of the medium; a fixing device including a heating member configured to heat the front surface of the medium and a pressing member configured to come into press contact with the heating member via the medium and heat a rear surface of the medium; and a control unit configured to turn off, when the thickness or the basis weight of the medium is determined to be equal to or smaller than a predetermined value based on an acquired characteristic of the medium, heating power for the pressing member at start of a fixing operation by the fixing device and control the temperature of the pressing member during the fixing operation to the temperature between a second threshold temperature which is temperature lower than a temperature during standby of the fixing operation, and a first threshold temperature lower than the second threshold temperature.

### First Embodiment

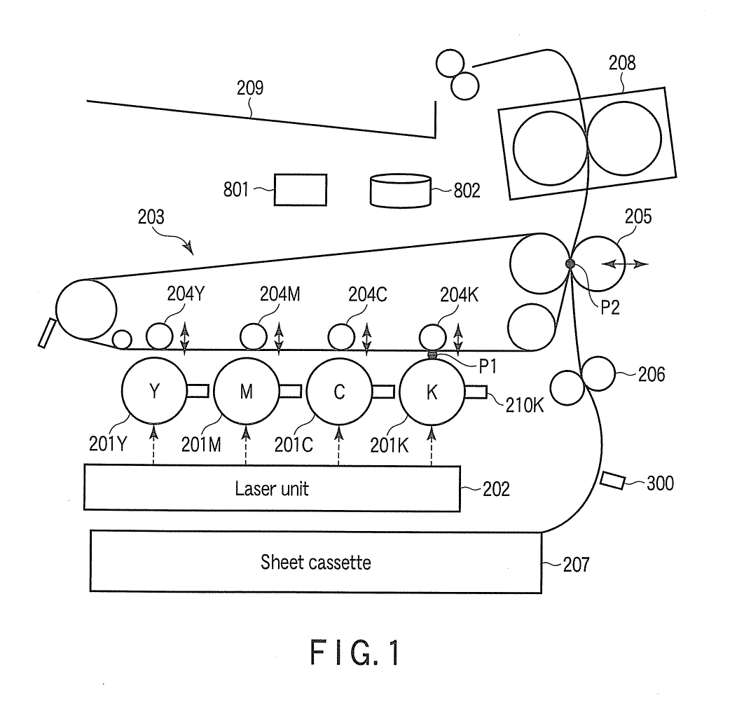

FIG. 1 is an exemplary overall diagram of an image forming apparatus according to an embodiment. The image forming apparatus shown in FIG. 1 is an electrophotographic recording apparatus of a quadruple tandem type.

The image forming apparatus includes photoconductive members 201Y to 201K, a laser unit 202, a transfer belt 203, primary transfer rollers 204Y to 204K, a secondary transfer roller 205, a registration roller 206, a sheet cassette 207, a fixing device 208, a paper discharge tray 209, a CPU 801, a memory 802, and a media sensor 300.

The CPU 801 collectively controls various kinds of processing in the image forming apparatus. The CPU 801 executes computer programs stored in the memory 802 to thereby realize various functions of the image forming apparatus. The memory 802 includes a ROM or a RAM and stores various kinds of information used in the image forming apparatus besides the computer programs.

An image forming operation in the image forming apparatus is explained below. The operation is explained concerning the photoconductive member 201K. This operation is the same concerning the other photoconductive members 201Y to 201C.

When image forming processing is started, the photoconductive surface of the photoconductive member 201K is cleaned according to the rotation of the photoconductive member 201K. Subsequently, after being subjected to charge removing processing, the photoconductive surface of the photoconductive member 201K is subjected to charging processing. The laser unit 202 applies exposure processing to a region of the photoconductive surface of the photoconductive member 201K subjected to the charging processing and forms an electrostatic latent image on the photoconductive surface. The electrostatic latent image is visualized by a two-component developer containing a toner and a carrier.

The transfer belt 203 comes into contact with and separates from the photoconductive member 201K according to the movement of the primary transfer roller 204K. A toner image visualized on the photoconductive member 201K is transferred from the photoconductive surface onto the belt surface of the transfer belt 203 in a predetermined transfer position P1 when the transfer belt 203 comes into contact with the photoconductive member 201K. Similarly, toner images of respective colors are transferred onto the transfer belt 203.

The secondary transfer roller 205 is arranged to be capable of coming into contact with and separating from the belt surface of the transfer belt 203. A medium conveyed from the sheet cassette 207 is pressed against the belt surface in a predetermined secondary transfer position P2 by the secondary transfer roller 205. The toner image is transferred onto the medium.

The media sensor 300 detects a characteristic of paper. The characteristic of paper is paper thickness, paper basis weight, or the like. In this embodiment, the media sensor 300 detects the paper thickness. The fixing device 208 heats and fixes the toner image, which is transferred onto the medium, according to the detected paper thickness. The medium is discharged to the paper discharge tray 209.

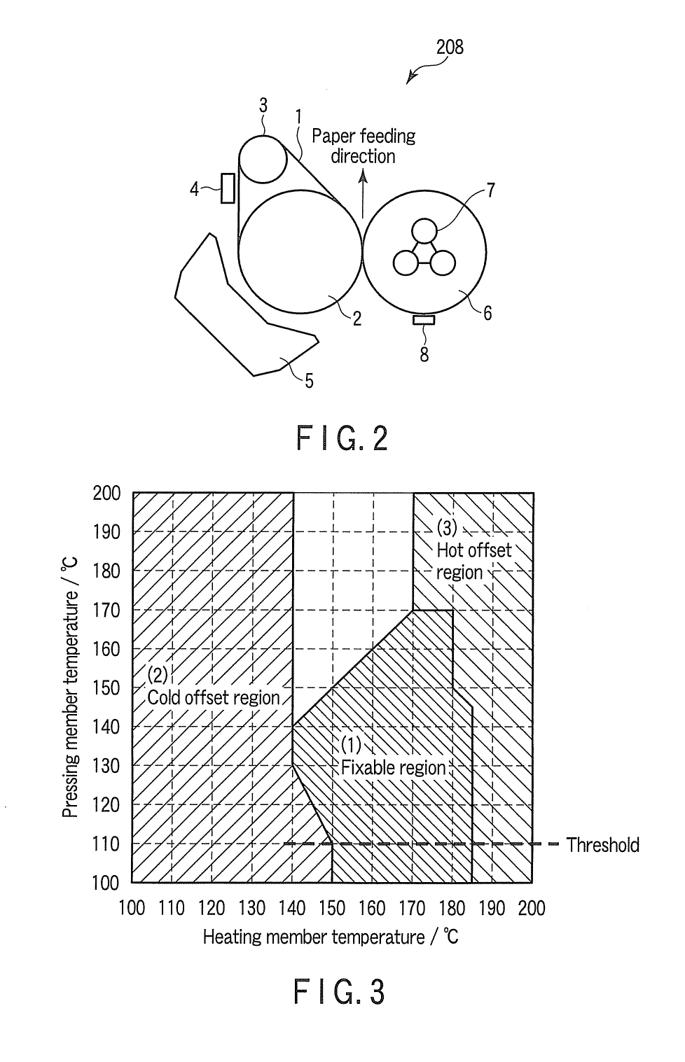

FIG. 2 is an exemplary overall diagram of the fixing device according to an embodiment.

The fixing device 208 includes a fixing roller 2 and a pressing roller 6 for heating and pressing a medium to which a toner adheres. A fixing belt 1 is stretched around the fixing roller 2 and a tension roller 3. The fixing belt 1 forms an endless track according to the rotation of the rollers 2 and 3. An IH coil unit 5 performs induction heating (IH) to heat the fixing belt 1. A temperature sensor 4 measures the temperature of the fixing belt 1.

The pressing roller 6 is provided to be opposed to the fixing roller 2. Heating sources 7 such as lamps are provided on the inside of the pressing roller 6. In FIG. 2, three heating sources 7 are shown. A temperature sensor 8 measures the surface temperature of the pressing roller 6.

In this embodiment, a heating member is the fixing belt 1. In a fixing device according to another embodiment, a fixing belt is not provided and a heating roller includes a heat generation source. In this configuration, the heating roller is the heating member. In this embodiment, a pressing member is the pressing roller 6. In a fixing device according to the other embodiment, instead of a pressing roller, a pressing belt presses a medium. In this configuration, the pressing belt is the pressing member.

The operation of the fixing device 208 is explained below.

The IH coil unit 5 performs electromagnetic induction heating to heat the fixing belt 1. The fixing belt 1 is driven by the rotation of the fixing roller 2 and the tension roller 3. The fixing roller 2 presses the fixing belt 1 against the pressing roller 6 using a spring or the like. On the other hand, the inside of the pressing roller 6 is also heated by the heating sources 7. Therefore, a region for heating a medium called nip is formed in a region where the fixing belt 1 and the pressing roller 6 are in contact with each other. The medium passes through the nip in a paper feeding direction, whereby a toner image formed on the medium is fused and fixed.

FIG. 3 is an exemplary diagram for explaining a region formed by the heating member and the pressing member of the fixing device according to an embodiment. The abscissa of FIG. 3 represents heating member temperature, i.e., the temperature of the fixing belt 1 and the ordinate represents pressing member temperature, i.e., the temperature of the pressing roller 6.

An offset phenomenon in the fixing device 208 is a phenomenon in which a toner adheres to the members of the fixing device 208 and remains when fusing of the toner is not proper. A fixable region (1) in FIG. 3 is a non-offset region, i.e., a region where the offset phenomenon does not occur. A cold offset region (2) in FIG. 3 is a region where the fusing of the toner is not sufficiently performed because temperature is low. When the fixing device 208 is used in this region, a toner on a medium surface adheres to the fixing belt 1. A hot offset region (3) in FIG. 3 is a region where the fusing of the toner excessively progresses, the elasticity of the toner falls, and the toner has adhesion. As a result, the toner peels and adheres to the fixing belt 1. Therefore, fixing temperature has to be controlled such that the fixing is performed in the fixable region.

On the other hand, if the pressing member temperature is lower than a predetermined value, the fixing is not normally performed. Therefore, a lowest limit is specified for the pressing member temperature. The image forming apparatus is designed to stop, when the pressing member temperature falls below the lowest limit, a printing operation until the pressing member temperature recovers (a wait state). Actually, it is desirable to set the lowest limit to a value (e.g., +10° C.) higher than a theoretical lowest limit in the fixable region taking into, for example, the fact that there is a temperature distribution in a longitudinal direction of the pressing member (a roller axis direction). In FIG. 3, a threshold T represents a lower limit in temperature control.

An idea of the fixing temperature control in this embodiment is explained below.

As explained above, the fixing device 208 executes the fixing control corresponding to paper thickness detected by the media sensor 300. In this embodiment, the paper thickness is classified into two classifications. Paper having paper thickness of 64 g/m² to 80 g/m² is classified as plain paper 1 and paper having paper thickness of 81 g/m² to 105 g/m² is classified as plain paper 2. For example, if the paper thickness of paper (media) put in the sheet cassette 207 by a user is 70 g/m², when the media sensor 300 detects the paper thickness 70 g/m², the fixing device 208 selects fixing control for the plain paper 1 and performs a fixing operation.

The operation of the fixing device 208 performed when the electric power is limited by providing an upper limit for electric power used in the fixing device 208 in order to reduce consumption of the electric power in the fixing device 208 is explained.

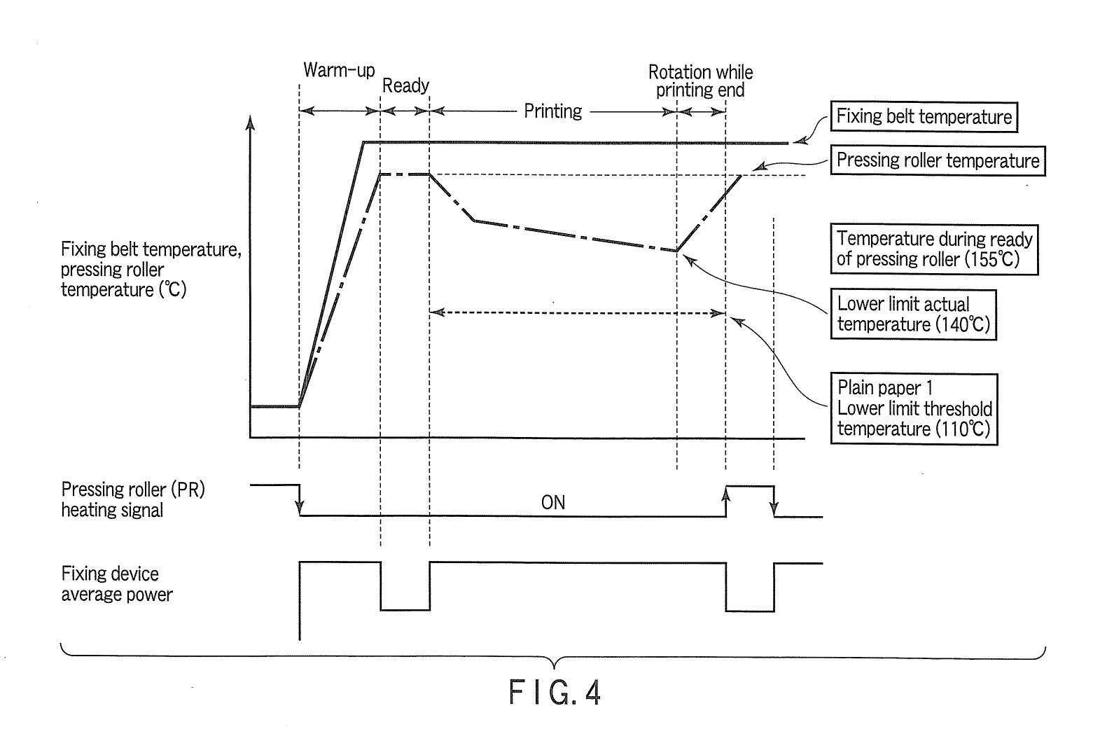

FIG. 4 is an exemplary time chart for explaining a temperature control state of the fixing device 208 in the case in which a power value is regulated with respect to the plain paper 1 according to an embodiment.

The ordinate of the coordinate axes represents the temperatures of the fixing belt 1 and the pressing roller 6 and the abscissa represents time. A solid line in the figure represents the transition of set temperature of the fixing belt 1 and an alternate long and short dash line represents the transition of actual temperature of the pressing roller 6. A dotted line represents lower limit threshold temperature (110° C.) of the plain paper 1. The transition of a heating signal to the heating sources 7 of the pressing roller 6 and the transition of average power of the fixing device 208 are shown according to these temperature transitions.

When a power supply for the image forming apparatus is turned on, warm-up is started. Regulated maximum power is applied to the fixing belt 1 and the pressing roller 6 and the temperatures of the fixing belt 1 and the pressing roller 6 rise. When the temperatures respectively reach predetermined values, the image forming apparatus changes to a ready state. The temperatures are respectively controlled to the predetermined values. Control temperature of the pressing roller 6 in the ready state is 155° C. Temperature in the ready state is set to a fixed value irrespective of paper thickness because the temperature is temperature for starting the fixing operation without trouble during printing. In the ready state, since the heat of the fixing device 208 is only deprived mainly by heat radiation, electric power in use falls.

When a printing operation is started, since a medium coming into contact with the pressing roller 6 deprives heat from the pressing roller 6, the temperature of the pressing roller 6 falls. In this case, a control operation is executed to keep the temperature of the pressing roller 6 at predetermined temperature (155° C.). Since the upper limit is provided for the electric power in use, the temperature of the pressing roller 6 continues to fall even if the electric power of the upper limit continues to be supplied. When the printing ends, the temperature of the pressing roller 6 rises because heat is not deprived by the medium. Thereafter, the operations explained above are repeated.

When the printing ends, the temperature of the pressing roller 6 falls to 140° C. However, a lower limit (140° C.) of this actual temperature is temperature higher than 110° C. which is lower limit threshold temperature of the plain paper 1. Since the temperature of the pressing roller 6 remains within the fixable region, fixing can be executed without trouble. Therefore, it is possible to regulate a power value with respect to the plain paper 1 and execute the fixing operation.

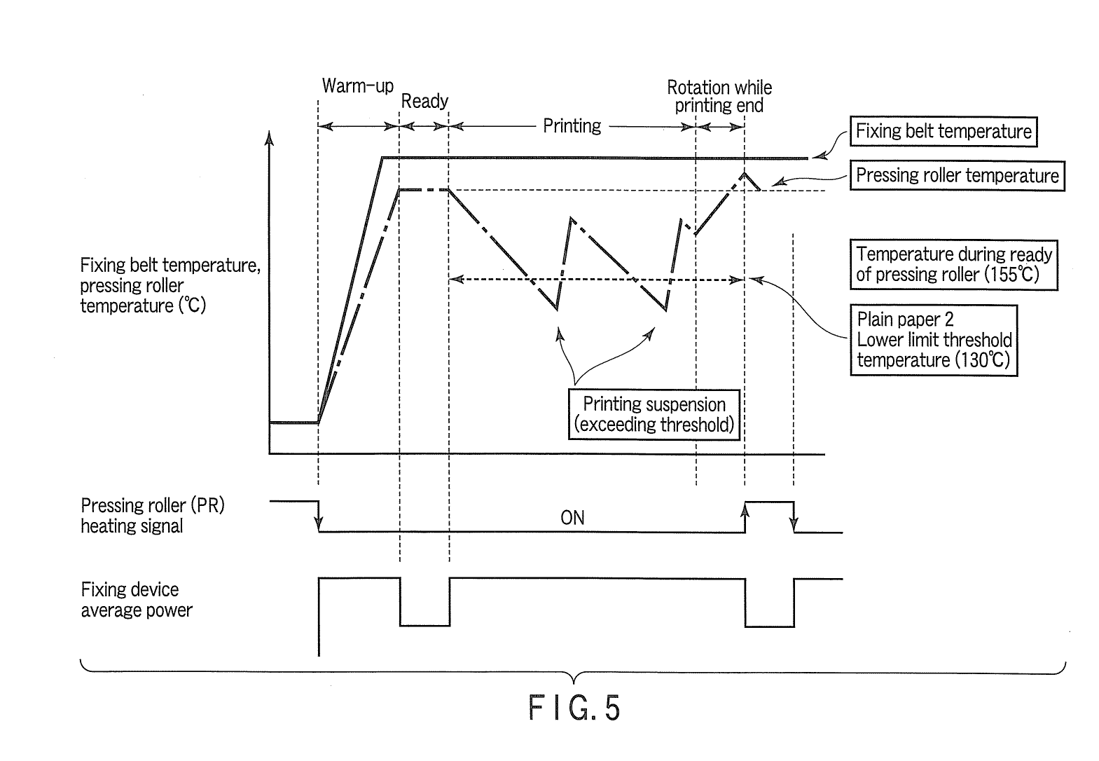

FIG. 5 is an exemplary time chart for explaining a temperature control state of the fixing device 208 in which a power value is regulated with respect to the plain paper 2 according to an embodiment.

When the power supply for the image forming apparatus is turned on, the warm-up is started. The regulated maximum power is applied to the fixing belt 1 and the pressing roller 6 and the temperatures of the fixing belt 1 and the pressing roller 6 rise. When the temperatures respectively reach the predetermined values, the image forming apparatus changes to be in the ready state. The temperatures are respectively controlled to the predetermined values. The control temperature of the pressing roller 6 in the ready state is 155° C. The temperature in the ready state is set to the fixed value irrespective of paper thickness because the temperature is the temperature for starting the fixing operation without trouble during printing. In the ready state, since the heat of the fixing device 208 is only deprived mainly by heat radiation, electric power in use falls.

When the printing operation is started, since a medium coming into contact with the pressing roller 6 deprives heat from the pressing roller 6, the temperature of the pressing roller 6 falls. In this case, the control operation is executed to keep the temperature of the pressing roller 6 at the predetermined temperature (155° C.). Since the upper limit is provided for the electric power in use, the temperature of the pressing roller 6 continues to fall even if the electric power of the upper limit continues to be supplied.

The plain paper 2 has paper thickness larger than that of the plain paper 1. Therefore, a heat removal amount from the pressing roller 6 is also larger and the temperature of the pressing roller 6 falls at higher speed. Lower limit threshold temperature of the plain paper 2 is 130° C. which is higher than the lower limit threshold temperature 110° C. of the plain paper 1. Therefore, the temperature of the pressing roller 6 falls below the lower limit threshold temperature and printing interruption occurs. When the printing is interrupted, since heat is not deprived by the medium, the temperature of the pressing roller 6 rises. Although the printing is resumed, the printing interruption occurs again because of a reason same as the reason explained above. Thereafter, the interruption and the resumption of the printing operation are repeated. When the printing ends, since heat is not deprived by the medium, the temperature of the pressing roller 6 rises. Thereafter, the operations explained above are repeated.

In this way, when the power value is regulated with respect to the plain paper 2 and the fixing operation is executed, as a result, the printing interruption frequently occurs. Therefore, it is inappropriate to regulate the power value with respect to the plain paper 2 and execute the fixing operation.

A fixing temperature control method in the image forming apparatus according to this embodiment is explained below.

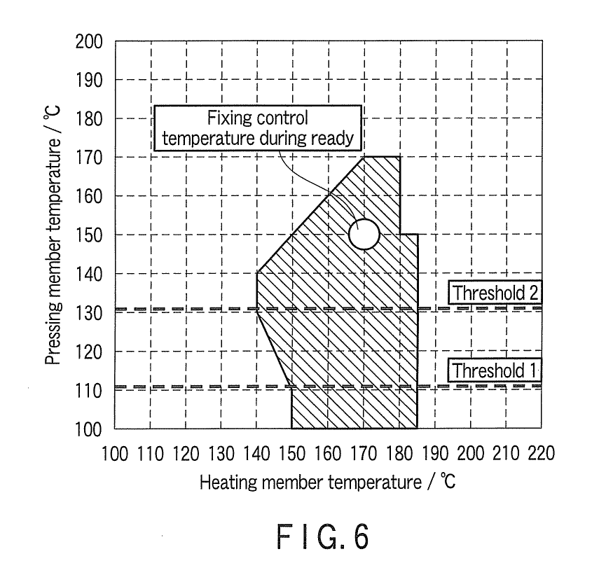

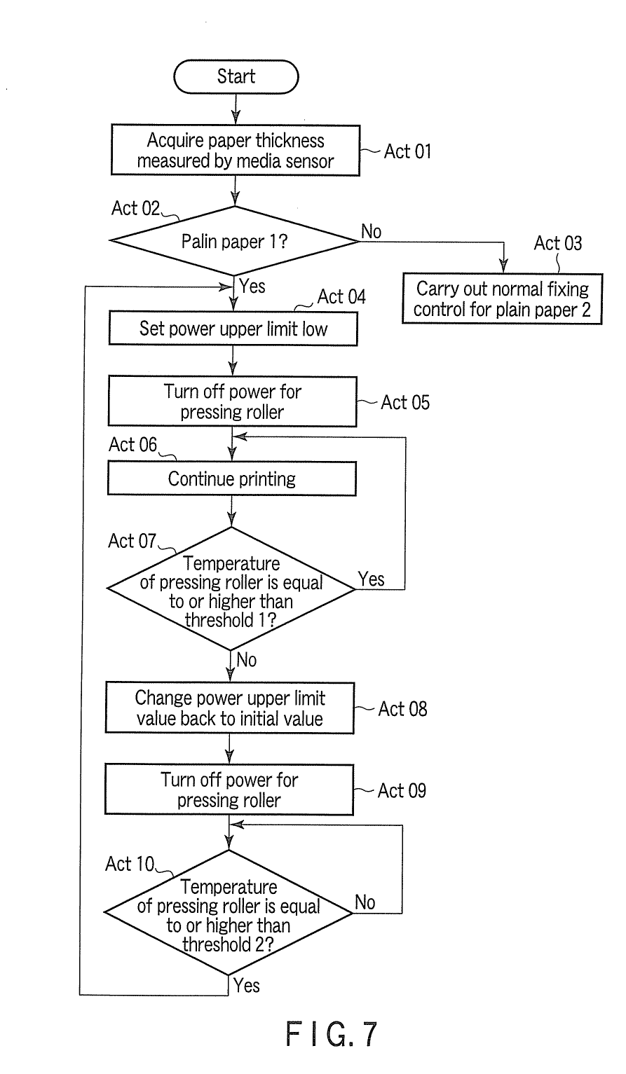

FIG. 6 is an exemplary diagram for explaining a temperature control operation of the fixing device according to an embodiment. FIG. 7 is an exemplary flowchart for explaining a temperature control procedure of the fixing device according to an embodiment. The temperature control operation of the fixing device is explained below with reference to FIGS. 6 and 7.

As shown in FIG. 6, as fixing control temperature during ready, for example, pressing member (pressing roller) temperature is 155° C. and heating member (fixing belt) temperature is 170° C. In this temperature control, the pressing member (pressing roller) temperature is set as a control target. Thresholds 1 and 2 for the temperature control are provided. The function of the thresholds 1 and 2 is explained later.

In Act 01 in FIG. 7, the CPU 801 acquires paper thickness detected by the media sensor 300. In Act 02, the CPU 801 checks whether a medium belongs to the class of the plain paper 1.

If the medium belongs to the class of the plain paper 2 (No in Act 02), the CPU 801 executes normal fixing control for the plain paper 2. Explanation of the normal fixing control is omitted.

If the medium belongs to the class of the plain paper 1 (Yes in Act 02), in Act 04, the CPU 801 sets the power upper limit of the fixing device 208 low. When the power upper limit is set low, it is possible to suppress consumption of electric power in a standby state.

When a printing operation is stared, in Act 05, as a first stage of the temperature control, the CPU 801 turns off electric power applied to the pressing roller 6. In Act 06, the CPU 801 continues the printing operation. During the printing continuation, the CPU 801 monitors the temperature of the pressing roller 6. In Act 07, the CPU 801 checks whether the temperature of the pressing roller 6 is equal to or higher than the threshold 1.

The threshold 1 is set to a value slightly higher than a lower limit threshold. Therefore, if the temperature of the pressing roller 6 is equal to or higher than the threshold 1 (Yes in Act 07), since fixing temperatures is within the fixable region, the CPU 801 continues the printing operation.

If the temperature of the pressing roller 6 is lower than the threshold 1 (No in Act 07), it is necessary to prevent a situation in which the temperature of the pressing roller 6 falls below the lower limit threshold and the printing is suspended. However, when electric power is simply applied to the pressing roller 6, as explained with reference to FIG. 4, it is conceivable that the temperature continues to fall.

Therefore, in Act 08, as a second stage of the temperature control, the CPU 801 returns the power upper limit of the fixing device 208 to an initial value thereof. In Act 09, the CPU 801 applies higher electric power to the pressing roller 6. Consequently, the temperature of the pressing roller 6 changes to rise.

In Act 10, the CPU 801 checks whether the temperature of the pressing roller 6 reaches the threshold 2. If the temperature of the pressing roller 6 does not reach the threshold 2 (No in Act 10), the CPU 801 continues a power-on state of the pressing roller 6. At this point, a printing state continues without stopping. If the temperature of the pressing roller 6 reaches the threshold 2 (Yes in Act 10), the CPU 801 returns to Act 04 and executes the temperature control in the first stage.

The threshold 2 is set as temperature lower than 155° C. which is fixing control temperature during the ready, and higher than the threshold 1. Therefore, in this temperature control method, during the printing operation, the temperature of the pressing roller 6 is controlled to temperature between the threshold 1 and the threshold 2. Therefore, since the temperature of the pressing roller 6 remains within the fixable region, it is possible to execute fixing without trouble.

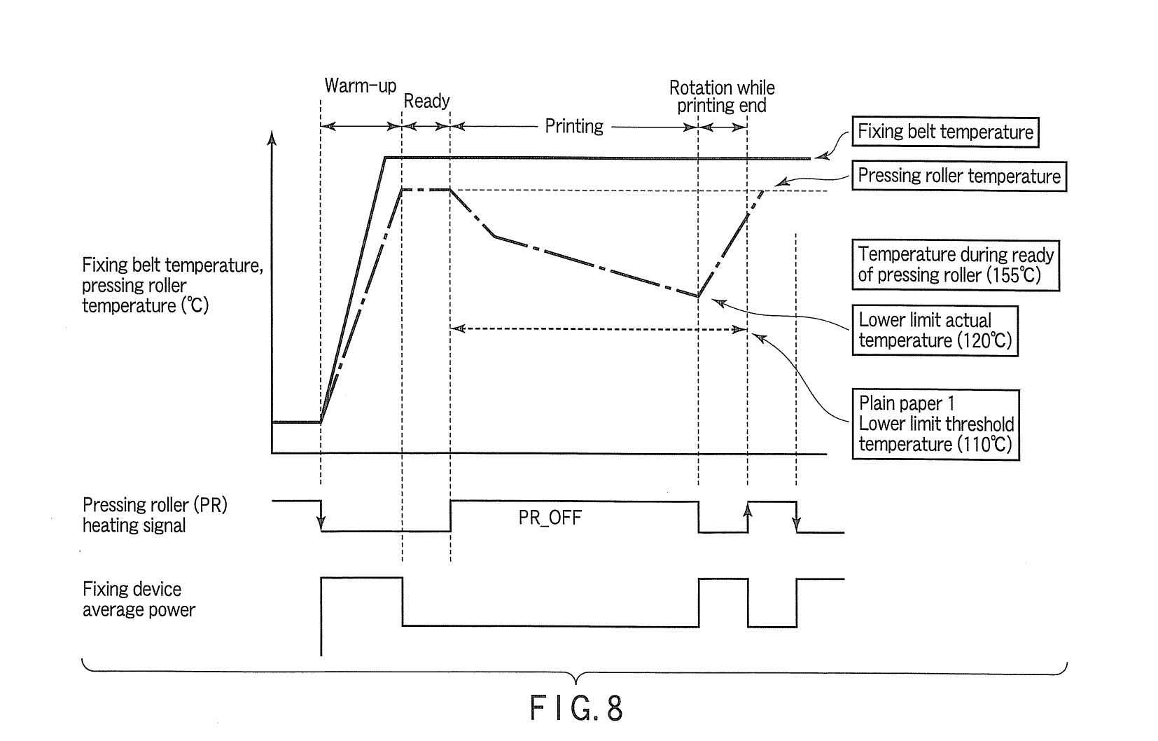

FIG. 8 is an exemplary time chart for explaining a temperature control state of the fixing device 208 in the case in which the temperature control in this embodiment is applied to the plain paper 1 according to an embodiment.

When the power supply for the image forming apparatus is turned on, the warm-up is started. The regulated maximum power is applied to the fixing belt 1 and the pressing roller 6 and the temperatures of the fixing belt 1 and the pressing roller 6 rise. When the temperatures respectively reach the predetermined values, the image forming apparatus changes to be in the ready state. The temperatures are respectively controlled to the predetermined values. The control temperature of the pressing roller 6 in the ready state is 155° C. The temperature in the ready state is set to the fixed value irrespective of paper thickness because the temperature is the temperature for starting the fixing operation without trouble during printing. In the ready state, since the heat of the fixing device 208 is only deprived mainly by heat radiation, electric power in use falls.

When the printing operation is started, a power supply for heating the pressing roller 6 is turned off. Since a medium coming into contact with the pressing roller 6 deprives heat from the pressing roller 6, the temperature of the pressing roller 6 falls. In this case, the control operation for keeping the temperature of the pressing roller 6 at the predetermined temperature (155° C.) is not performed. Therefore, the temperature of the pressing roller 6 falls at speed faster than the temperature fall speed shown in FIG. 4. However, since the paper thickness of the medium is small, a heat removal amount is small. As a result, when the printing ends, the temperature of the pressing roller 6 falls to 120° C. The lower limit (120° C.) of the actual temperature is temperature higher than 110° C. which is the lower limit threshold temperature of the plain paper 1. The temperature of the pressing roller 6 remains within the fixable region. It is possible to further reduce power consumption and execute fixing without trouble by utilizing this control method.

If the temperature of the pressing roller 6 further falls to be lower than the threshold 1 during the printing, electric power is applied to the pressing roller 6 until the temperature of the pressing roller 6 reaches the predetermined threshold 2. Then, the electric power is turned off again. The threshold 2 is a value lower than the temperature in the ready state. Therefore, even if heating of the pressing roller 6 occurs during the printing, it is possible to reduce electric energy compared with a system for always keeping electric power on as in the conventional temperature control.

The image forming apparatus has an automatic mode for automatically selecting the classes of the plain paper (e.g., the plain paper 1 and the plain paper 2) on the basis of paper thickness information detected by the media sensor 300 and a manual mode set by the user selecting the class of the plain paper in advance. In the embodiment, the temperature control operation in the automatic mode is explained. However, it goes without saying that the present invention can be applied in the manual mode in the same manner.

A characteristic of a medium to be detected is not limited to the paper thickness and may be basis weight. Specifically, the image forming apparatus may have an automatic mode for automatically selecting the classes of the plain paper (e.g., the plain paper 1 and the plain paper 2) on the basis of basis weight information detected by the media sensor 300 and a manual mode set by the user selecting the class of the plain paper. It goes without saying that the temperature control can be realized by both the automatic mode and the manual mode.

The characteristic of a medium to be detected by a media sensor is not limited to paper thickness or basis weight. For example, the resistance or light transmission characteristic of a medium may be detected, and paper thickness or basis weight may be acquired from the detected value. A relation between the resistance or light transmission characteristic of a medium and the paper thickness or basis weight may be predetermined based on actual measurements. In this case, the paper thickness or basis weight can be acquired based on the detected resistance or light transmission characteristic by applying the predetermined relation.

In the embodiment, the power upper limit of the fixing device 208 is set low before the start of the printing. However, the power upper limit may be kept without being changed. This is because, even if the ready state in which the start of the printing is put on standby is not long, a power reducing effect by turn-off of the electric power for the pressing roller 6 is recognized.

The functions explained in the embodiment may be configured by using hardware. A computer program describing the functions may be read by using software, to cause a computer to read the computer program. The functions may be configured by selecting the software or the hardware as appropriate.

It is also possible to realize the functions by causing the computer to read the computer program stored in a not-shown recording medium. A recording form of the recording medium in this embodiment may be any form as long as the recording medium can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form a toner image on a front surface of a medium;
a characteristic acquiring unit configured to acquire a characteristic of the medium;
a fixing device including a heating member configured to heat the front surface of the medium and a pressing member configured to come into press contact with the heating member via the medium and heat a rear surface of the medium; and
a control unit configured to turn off, when the thickness or the basis weight of the medium is determined to be equal to or smaller than a predetermined value based on an acquired characteristic of the medium, heating power for the pressing member at start of a fixing operation by the fixing device and control the temperature of the pressing member during the fixing operation to the temperature between a second threshold temperature which is temperature lower than a temperature during standby of the fixing operation, and a first threshold temperature lower than the second threshold temperature.

2. The apparatus according to claim 1, further comprising a temperature sensor configured to detect the temperature of the pressing member, wherein
when the temperature sensor detects that the temperature of the pressing member is equal to or lower than the first threshold temperature, the control unit turns on the heating power for the pressing member.

3. The apparatus according to claim 2, wherein, after turning on the heating power for the pressing member, when the temperature sensor detects that the temperature of the pressing member is equal to or higher than the second threshold temperature, the control unit turns off the heating power for the pressing member.

4. The apparatus according to claim 3, further comprising a media sensor configured to detect the characteristic of the medium, wherein
the characteristic acquiring unit acquires a resistance or light transmission value detected by the media sensor.

5. The apparatus according to claim 3, further comprising a setting unit in which the thickness or the basis weight of the medium is set and input, wherein
the characteristic acquiring unit acquires the thickness or the set and input basis weight.

6. The apparatus according to claim 1, wherein the control unit sets an upper limit of a power value used in the fixing device low before the fixing device starts the fixing operation.

7. The apparatus according to claim 6, further comprising a temperature sensor configured to detect the temperature of the pressing member, wherein
when the temperature sensor detects that the temperature of the pressing member is equal to or lower than the first threshold temperature, the control unit changes the lower limit of the power value set low back to an initial value thereof and turns on the heating power for the pressing member.

8. The apparatus according to claim 7, wherein, after turning on the heating power for the pressing member, when the temperature sensor detects that the temperature of the pressing member is equal to or higher than the second threshold temperature, the control unit turns off the heating power for the pressing member.

9. The apparatus according to claim 8, further comprising a media sensor configured to detect the characteristic of the medium, wherein
the characteristic acquiring unit acquires a resistance or light transmission value detected by the media sensor.

10. The apparatus according to claim 8, further comprising a setting unit in which the thickness or the basis weight of the medium is set and input, wherein
the characteristic acquiring unit acquires the set and input thickness or the basis weight.

11. An image forming method for an image forming apparatus including: an image forming unit configured to form a toner image on a front surface of a medium; and a fixing device including a heating member configured to heat the front surface of the medium and a pressing member configured to come into press contact with the heating member via the medium and heat a rear surface of the medium, the method comprising:
acquiring a characteristic of the medium; and
turning off, when the characteristic of the medium is determined to be equal to or smaller than a predetermined value based on an acquired characteristic of the medium, heating power for the pressing member at start of a fixing operation by the fixing device and controlling the temperature of the pressing member during the fixing operation to the temperature between a second threshold temperature which is temperature lower than a temperature during standby of the fixing operation, and a first threshold temperature lower than the second threshold temperature.

12. The method according to claim 11, further comprising turning on the heating power for the pressing member when a temperature sensor configured to detect the temperature of the pressing member detects that the temperature of the pressing member is equal to or lower than the first threshold temperature.

13. The method according to claim 12, further comprising turning off, after turning on the heating power for the pressing member, the heating power for the pressing member when the temperature sensor detects that the temperature of the pressing member is equal to or higher than the second threshold temperature.

14. The method according to claim 13, wherein the characteristic of the medium to be acquired is a resistance or light transmission value detected by a media sensor.

15. The method according to claim 13, wherein the characteristic of the medium to be acquired is set and input thickness or basis weight.

16. The method according to claim 11, further comprising setting an upper limit of a power value used in the fixing device low before the fixing device starts the fixing operation.

17. The method according to claim 16, further comprising changing, when the temperature sensor detects that the temperature of the pressing member is equal to or lower than the first threshold temperature, the lower limit of the power value set low back to an initial value thereof and turning on the heating power for the pressing member.

18. The method according to claim 17, further comprising turning off, after turning on the heating power for the pressing member, the heating power for the pressing member when the temperature sensor detects that the temperature of the pressing member is equal to or higher than the second threshold temperature.

19. The method according to claim 18, wherein the characteristic of the medium to be acquired is a resistance or light transmission value detected by a media sensor.

20. The method according to claim 18, wherein the characteristic of the medium to be acquired is set and input thickness or basis weight.
